(19) United States
(12) Patent Application Publication
(10) Pub. No.: US 2026/0205313 A1
(43) Pub. Date: Jul. 16, 2026

(54) Primary Patent (Foundational): System and Method for the BEI _24HWS Human Sovereignty Ecological System Defensive Patent (Anti-Simulation): Defensive Framework and Anti-Simulation Constructs for the BEI _ 24HWS Sovereignty Architecture

(71) Applicant: FURONG BEI, SAN GABRIEL, CA (US)

(72) Inventor: FURONG BEI, SAN GABRIEL, CA (US)

(21) Appl. No.: 19/187,223

(22) Filed: Apr. 23, 2025

(51) Int. Cl. H04L 9/32

(52) U.S. Cl. CPC H04L 9/3268; H04L 9/3213; H04L 9/3218; H04L 9/3236; H04L 9/3247

(57) ABSTRACT

Disclosed are computer-implemented systems, methods, and non-transitory computer-readable media for a sovereignty architecture that integrates self-sovereign identity, behavior-verified value issuance, and numberless secure communications. A ReadName-linked identity state is associated with one or more domain-namespace records and a ReadVault event ledger. Behavior records from authorized sources are bound to cryptographic time-proofs having validity windows and replay-prevention state. Upon successful verification, a minting engine performs an atomic transition that issues time-denominated value units, binds each issuance to the identity state, and generates a mint certificate and a state-transition receipt. A routing layer resolves domain basepoints to signed endpoint records for policy retrieval, audit, minting, clearing, and settlement. A communication layer derives encrypted numberless endpoints and establishes policy-controlled communications through sovereign endpoint nodes, enabling auditable, privacy-preserving, and interoperable operation across sectors and jurisdictions.

### CROSS-REFERENCE TO RELATED APPLICATIONS

This application is drafted as a formal mother-case specification directed to a computer-implemented sovereignty architecture that integrates namespace-anchored identity, policy-controlled issuance of time- or behavior-linked value units, machine-verifiable proof processing, authenticated endpoint routing, numberless secure communications, and lifecycle controls including inheritance, revocation, audit, dispute handling, and bounded rollback.

The present disclosure is written to preserve a broad and technically grounded support base for claims directed to Identity Anchors, ReadName identifiers, Authorized Sources, Event Records, Behavior Records, Time-Proofs, Policy Bundles, Decision Receipts, Mint Certificates, Settlement Receipts, Signed Endpoint Records, RedName communications flows, BEIProof proof-layer operations, interoperability mappings, and related non-limiting implementations described herein.

Any domestic-benefit, continuation, divisional, continuation-in-part, or other continuity relationship intended to be legally relied upon should be set forth in the Application Data Sheet or other official filing record. References to related filings in the present specification are provided to orient the disclosure and to explain overlapping technical subject matter, not to replace the formal function of an Application Data Sheet.

Where permitted by law and not inconsistent with the present disclosure, one or more related applications concerning identity resolution, proof-layer services, policy-controlled authorization, time-governed issuance, domain or namespace routing, clearinghouse settlement, registry layers, and distributed infrastructure may provide contextual support for optional implementations. Nevertheless, the present application is intended to stand on its own as a unified disclosure for the presently claimed architecture.

### STATEMENT REGARDING FEDERALLY SPONSORED RESEARCH OR DEVELOPMENT

Not applicable.

### TECHNICAL FIELD

The present disclosure relates generally to distributed computing, distributed ledgers, cryptographically verifiable event processing, privacy-preserving identity systems, machine-verifiable routing objects, policy-controlled issuance systems, secure communications, and interoperable exchange, clearing, and settlement frameworks.

More particularly, the disclosure relates to a sovereignty architecture in which a resolvable namespace-linked identity anchor cooperates with Authorized Sources, canonicalized Event Records, Time-Proofs, signed and versioned Policy Bundles, atomic mint-and-bind operations, Signed Endpoint Records, privacy-preserving presentation techniques, and settlement-state controls to enable a technically integrated system for issuance, routing, communications, audit, and lifecycle governance.

In non-limiting embodiments, the disclosure may be implemented across one or more consumer devices, enterprise nodes, institutional gateways, policy-publishing services, proof-verification services, minting engines, clearinghouse services, communication nodes, audit nodes, beneficiary-transfer engines, or hybrid on-chain/off-chain integrity infrastructures. The described architecture is not restricted to one consensus family, one ledger type, one transport stack, or one commercial deployment brand.

### BACKGROUND AND TECHNICAL PROBLEMS

Conventional digital platforms commonly separate identity, value, communications, and settlement into independently administered systems controlled by centralized intermediaries. As a result, a user may authenticate through one account system, communicate through another, receive value credits through a third, and settle or redeem through yet another, with each subsystem maintaining its own permissions, addressing conventions, logs, and lifecycle controls. This fragmentation increases technical friction and undermines reliable machine-verifiable linkage between an event, a subject, a rule set, an issuance outcome, and a later audit or settlement state.

Traditional account-centric systems also tend to rely on mutable or platform-scoped identifiers that are not readily portable across independent operators. Even when public-key infrastructure is used, the practical discovery of authoritative endpoints, revocation information, policy state, or audit permissions is often scattered across separate services with inconsistent trust semantics. A subject may possess a nominal identifier without an integrated method for resolving minting endpoints, proof endpoints, communication endpoints, audit endpoints, or beneficiary-transfer endpoints under a consistent verification framework.

In existing tokenized or points-based systems, issuance decisions are frequently opaque, manually reviewable only, or tied to narrow application-specific rules that are neither portable nor independently auditable. Some systems accept event-like inputs but do not preserve reliable provenance, freshness, replay resistance, or deterministic policy versioning. Other systems expose balances without linking those balances to a machine-verifiable proof of why the balance exists, under which rule version it was created, or whether the associated lifecycle constraints include transfer conditions, lock-periods, revocation risk, or beneficiary restrictions.

So-called time-banking, credits, or reward systems may provide limited local utility, but they often lack a robust method for binding a verified activity to a subject-specific identity anchor through a proof object having a validity window and replay-prevention state. In many such systems, fraudulent duplication, issuer inconsistency, fabricated claims, stale events, or untracked modifications remain difficult to detect or explain because the systems lack a consistent canonicalization pipeline, a cryptographically verifiable Time-Proof, or a policy engine that publishes a signed and versioned ruleset used during issuance.

Communications systems present a related technical deficiency. Telephone-number-based or SIM-tethered routing remains widespread, yet such schemes are poorly matched to systems in which authority, eligibility, or routing should derive from an identity anchor and a machine-verifiable endpoint object rather than from a carrier-issued number. Even encrypted communication tools frequently depend on opaque service discovery, non-portable directory layers, or application-specific addressing that cannot cleanly interoperate with issuance, proof, audit, or settlement services.

Further technical problems arise in environments requiring downstream settlement, external rail interoperability, or institutional compliance. Without standardized receipts or endpoint-authenticated instructions, independent nodes may be unable to confirm whether an issuance decision is final, subject to review, reversible under bounded conditions, or already mirrored to another rail. Likewise, a later settlement actor may be able to see a transfer instruction without seeing the policy version, proof reference, or provenance state needed to assess whether the transfer should be honored, quarantined, denied, or routed to a dispute workflow.

Lifecycle management presents additional deficiencies. A subject's rights may need to survive key rotation, delegated authorization, temporary suspension, inheritance events, beneficiary designation, or dispute-triggered freezes. Many systems either omit such lifecycle states from the technical design or treat them as afterthoughts implemented outside the core architecture. This disconnect weakens auditability and creates inconsistency between the issuance state, the communication state, and the entitlement or transfer state.

Accordingly, a need exists for a technically integrated architecture that binds identity-anchored behavior evidence and Time-Proofs to deterministic policy evaluation, atomic mint-and-bind issuance, authenticated endpoint routing, numberless secure communications, machine-verifiable receipts, settlement/finality semantics, and lifecycle controls such as inheritance, revocation, dispute handling, and bounded rollback.

### HIGH-LEVEL SUMMARY OF THE DISCLOSURE

The disclosed architecture receives an Authorized Source behavior record, canonicalizes the record, binds the record or a commitment thereof to a Time-Proof having a Validity Window and replay-prevention state, evaluates the record and proof under a signed and versioned Policy Bundle, and, upon successful verification, executes a single atomic mint-and-bind transition that produces one or more value units together with machine-verifiable receipts.

In one aspect, the architecture includes an identity sovereignty layer configured to establish and manage an Identity Anchor associated with a resolvable namespace identifier, one or more cryptographic credentials, an authorization state, a revocation state, an inheritance or beneficiary state, and one or more Signed Endpoint Records. A ReadName identifier is a non-limiting user-readable expression of such an Identity Anchor.

In another aspect, the architecture includes a time sovereignty layer configured to receive Event Records or Behavior Records from Authorized Sources, generate or verify Time-Proofs, enforce signed and versioned Policy Bundles with effective time windows, and execute atomic minting transitions that bind issued value units to an Identity Anchor while producing a Mint Certificate, a Decision Receipt, and, where applicable, a Settlement Receipt or other receipt objects. In non-limiting embodiments, issued units may be referred to as TimeCoin, TimeCurrency, TimeToken, or other time- or behavior-linked value representations.

In yet another aspect, the architecture includes a communication sovereignty layer configured to derive or resolve communication endpoints from a namespace-linked Identity Anchor without requiring telephone-number or SIM-based addressing. A RedName communications protocol is one non-limiting example. The communications layer may authenticate Signed Endpoint Records, enforce policy-bounded routing, establish encrypted sessions, rotate ephemeral addressing material, and record non-sensitive communication-state integrity information.

In certain embodiments, the architecture further includes privacy-preserving presentations, proof issuance and proof verification services, interoperability mappings to external rails, exchange admission services, clearinghouse and settlement interfaces, finality indicators, inheritance or beneficiary-transfer logic, dispute handling, anomaly controls, revocation workflows, quarantine states, and bounded rollback mechanisms. These components may be independently deployed while remaining interoperable through common receipt semantics and endpoint-authenticated instructions.

The disclosed architecture improves technical reliability and interoperability by combining canonicalized event processing, replay-resistant Time-Proofs, deterministic policy enforcement, atomic mint-and-bind issuance, authenticated endpoint routing, privacy-preserving lifecycle controls, and machine-verifiable receipt semantics in a common framework that can be deployed across heterogeneous systems.

### BRIEF DESCRIPTION OF THE DRAWINGS

FIG. 1 illustrates an example high-level architecture including Identity-Anchor services, proof-verification services, minting services, communications services, ledger infrastructure, routing services, and audit or analytics services.

FIG. 2 illustrates an example namespace-anchored identity resolution flow including a namespace identifier, endpoint resolution, public-key credential association, key rotation, revocation state, and policy-aware endpoint verification.

FIG. 3 illustrates an example Event Record intake and Time-Proof generation flow including canonicalization, commitment generation, replay-prevention material, issuer attestation, and verification.

FIG. 4 illustrates an example Policy Bundle evaluation and atomic minting flow including a decision engine, policy versioning, mint certificate generation, and decision receipt output.

FIG. 5 illustrates an example numberless communication flow including endpoint derivation or resolution, encrypted channel establishment, and metadata protection.

FIG. 6 illustrates an example Signed Endpoint Record structure and routing among minting, audit, policy, exchange, clearing, settlement, proof, or beneficiary-transfer services.

FIG. 7 illustrates an example settlement and clearing flow including exchange-rate inputs, provenance identifiers, atomic settlement, finality states, and Settlement Receipts.

FIG. 8 illustrates an example inheritance and beneficiary-transfer workflow including trigger validation, succession rules, beneficiary designation, and auditable transfer receipts.

FIG. 9 illustrates an example privacy-preserving presentation used to prove satisfaction of one or more issuance or eligibility rules without disclosing unnecessary sensitive data.

FIG. 10 illustrates an example anomaly detection, supervisory review, dispute, revocation, and bounded rollback workflow.

### DEFINITIONS AND GLOSSARY

Identity Anchor: a binding between a resolvable namespace identifier, one or more cryptographic credentials, and an authorization, revocation, inheritance, delegation, or lifecycle state associated with a subject, organization, role, or device.

Resolvable Namespace Identifier: a domain, subdomain, route, namespace path, user-readable identifier, or equivalent naming construct resolvable to one or more authoritative endpoints and corresponding verification metadata.

ReadName: a non-limiting example of a self-sovereign namespace-linked identity identifier bound to an Identity Anchor.

Event Record: a structured record describing one or more activities, time quantities, contextual descriptors, attestations, evidence commitments, freshness data, and anti-replay elements.

Behavior Record: an Event Record in which at least one field represents a verified action, activity, service, contribution, fulfillment, interaction, or measurable conduct.

Authorized Source: an entity, device, institution, software agent, threshold group, or other system authorized under a Policy Bundle to issue, sign, attest to, or otherwise provide a Behavior Record or related verification input.

Time-Proof: a cryptographic object that binds an Event Record or a canonicalized representation thereof to an Identity Anchor, a time reference, a Validity Window, replay-prevention material, and one or more verifiable credentials, signatures, proofs, or attestations.

Validity Window: a bounded time interval, including but not limited to an epoch window, effective time window, sliding window, session window, or policy-defined interval, within which a Time-Proof, endpoint state, or policy state is valid for a corresponding operation.

Policy Bundle: a signed, versioned, machine-readable ruleset defining Authorized Sources, eligible categories, weighting factors, caps, rate limits, routing rules, privacy constraints, exception states, settlement permissions, beneficiary conditions, and audit permissions.

Decision Receipt: a tamper-evident record generated by a policy decision engine and containing one or more of policy version, rule identifier, reason code, risk score, freshness state, proof reference, endpoint reference, and timestamp.

Mint Certificate: a machine-verifiable record associating a minted unit with an Identity Anchor, a proof reference, a policy version, and one or more lifecycle or transfer constraints.

Settlement Receipt: a tamper-evident record associated with conversion, exchange, netting, transfer, reconciliation, or settlement, and containing one or more of finality state, rate snapshot, provenance identifier, policy reference, counterparty reference, and timestamp.

Signed Endpoint Record: an authenticated routing object that resolves a namespace or sub-namespace to one or more service endpoints, interface versions, public-key references, revocation pointers, policy pointers, audit pointers, or validity states.

BEIProof: a non-limiting example name for a proof-layer service, proof issuance service, proof-verification service, privacy-preserving proof service, proof-audit service, or related protocol component.

Domain Basepoint/Namespace Basepoint: a human-readable identifier, including a domain name, subdomain, route, or namespace path, that resolves to one or more Signed Endpoint Records used to discover authoritative protocol services.

Endpoint Record: a signed mapping from a Domain Basepoint or Namespace Basepoint to one or more protocol service endpoints, optionally including one or more endpoint roles, public-key references, policy pointers, revocation pointers, interface versions, jurisdiction tags, audit pointers, and validity windows.

Tamper-Evident Data Structure: a data structure that provides integrity evidence against unauthorized modification, including but not limited to a distributed ledger, permissioned ledger, append-only log, Merkle-based log, WORM storage, hybrid commitment structure, or equivalent integrity-preserving arrangement.

Interoperability Mapping: a transformation, translation, adapter, or equivalent mapping from an internal message, receipt, instruction, or settlement object to a standardized external format, external rail, or external interface.

RedName: a non-limiting example of a numberless communications protocol that derives or resolves communication endpoints from a namespace-linked Identity Anchor rather than a telephone number.

TimeCoin: a non-limiting example of a time- or behavior-linked value unit minted under policy control based on one or more verified Event Records.

The foregoing terms are illustrative and non-limiting. A particular commercial name, software stack, deployment domain, ledger family, or institutional operator should not be understood as limiting the disclosure unless a claim expressly recites such a limitation.

### DETAILED DESCRIPTION

### General Architecture

In one embodiment, the disclosed system comprises one or more client devices, identity-resolution nodes, proof-verification nodes, policy-management nodes, minting nodes, communications nodes, exchange or clearing nodes, audit nodes, beneficiary-transfer nodes, and one or more Tamper-Evident Data Structures. One or more nodes may be combined, partitioned, virtualized, or geographically separated. Some functions may be performed by a single operator, while other functions may be independently operated yet interoperable by virtue of common receipt semantics and endpoint-authenticated instructions.

Client devices may include mobile devices, browser-based applications, enterprise terminals, secure workstations, kiosks, embedded systems, or other devices capable of presenting a user interface, holding credentials, initiating requests, or consuming endpoint-authenticated responses. In some implementations, a client device directly interacts with a namespace resolver and proof-verification service; in other implementations, the client device interacts through one or more gateway services or application-specific orchestration layers.

The ledger infrastructure may be implemented as a distributed ledger, permissioned ledger, partitioned ledger, hybrid ledger, append-only receipt log, or other Tamper-Evident Data Structure. Detailed records may remain off-chain or in encrypted storage while commitments, revocation states, proof references, receipt hashes, integrity anchors, or endpoint state references are recorded in a tamper-evident layer. This arrangement permits high-integrity lifecycle tracking without requiring every sensitive payload to be stored in the same manner.

Identity, proof generation, issuance, communications, and settlement functions can be independently deployed while remaining interoperable through namespace resolution, authenticated endpoint routing, shared Policy Bundle semantics, and machine-verifiable receipts. Accordingly, the architecture supports heterogeneous deployment patterns while preserving a common verification grammar that may be consumed by client devices, institutional gateways, or third-party audit tools.

In certain embodiments, independently deployed nodes exchange machine-verifiable receipts, endpoint-authenticated instructions, and policy-governed state references such that issuance, routing, audit, exchange, clearing, and settlement remain interoperable without requiring a single centralized operator. Common receipt semantics allow heterogeneous implementations to confirm provenance, finality, and lifecycle status while preserving local deployment flexibility.

The high-level technical spine of the architecture may be summarized as follows. A Behavior Record is received from an Authorized Source. The record is canonicalized and bound to a Time-Proof having a Validity Window and replay-prevention state. A signed and versioned Policy Bundle is loaded and applied. Upon successful verification, a minting engine executes a single atomic mint-and-bind transition that creates one or more value units and associates those value units with an Identity Anchor. One or more Decision Receipts, Mint Certificates, Settlement Receipts, or communication-state integrity records may then be emitted, stored, routed, or later verified by downstream services.

### Identity Sovereignty Layer

The identity sovereignty layer establishes one or more Identity Anchors. Each Identity Anchor may be bound to a namespace identifier, one or more public-key credentials, an authorization state, a revocation state, an inheritance or beneficiary state, delegated-role metadata, device-linked metadata, and one or more Signed Endpoint Records. The disclosure does not require a single identity model. Rather, the Identity Anchor serves as the machine-verifiable locus through which rights, permissions, proof eligibility, endpoint discovery, communications routing, and beneficiary controls may be organized.

In some embodiments, a ReadName identifier is generated, registered, or resolved as a user-readable expression of an Identity Anchor. The ReadName may be created through a user-driven registration workflow, delegated issuance workflow, institution-assisted workflow, or hybrid workflow. The resulting ReadName may be bound to a Domain Basepoint, Namespace Basepoint, sub-route, or hierarchical namespace tree. Multiple human-readable expressions may resolve to the same underlying Identity Anchor, and one namespace may resolve to different endpoint roles under different Signed Endpoint Records.

Identity Anchors may support key rotation, credential replacement, revocation-list checking, delegated authorization, selective disclosure, and auditable lifecycle updates. For example, an Identity Anchor may hold a primary credential for direct user authentication, one or more recovery or guardian credentials for continuity, a delegated organizational credential for enterprise-controlled actions, and one or more policy-governed service credentials for automated workflows. Revocation of one credential does not necessarily extinguish the Identity Anchor; rather, the system may update credential validity while preserving auditable continuity.

A namespace resolver maps a namespace identifier to one or more Signed Endpoint Records identifying policy, minting, audit, communications, exchange, clearing, settlement, inheritance, proof, or beneficiary-transfer services. In some embodiments, a Signed Endpoint Record includes one or more of: a basepoint or namespace identifier, an endpoint role, a service URI or route, a public-key reference, a policy pointer, a revocation pointer, an interface version, a validity window, a jurisdiction tag, and an audit pointer. The Signed Endpoint Record may be verified before endpoint use to confirm endpoint authenticity, current validity, and applicable policy state.

In one embodiment, identity lifecycle processing comprises: creating or registering a ReadName identifier associated with an Identity Anchor; resolving the identifier to a Signed Endpoint Record; authenticating at least one public-key reference and validity state; performing one or more of key rotation, revocation checking, delegated authorization verification, or selective presentation; and, where applicable, applying inheritance or beneficiary-transfer conditions to identity-linked rights, credentials, or controlled references.

The identity sovereignty layer may also support role-based endpoint branching. A single Namespace Basepoint may resolve to different role-tagged Signed Endpoint Records such as a proof endpoint, a minting endpoint, a communications endpoint, a settlement endpoint, or an audit endpoint. This role separation permits one namespace-linked Identity Anchor to coordinate multiple technical services without requiring the subject to maintain separate platform-scoped account identifiers for each service.

In certain embodiments, identity-related eligibility may be proven through privacy-preserving presentation techniques. A subject may prove that the subject corresponds to a valid Identity Anchor, belongs to an eligible class, possesses a required authorization state, or satisfies a threshold condition without revealing unnecessary underlying attributes. Such selective disclosure may be performed through one or more verifiable credentials, encrypted attestations, zero-knowledge techniques, or equivalent privacy-preserving proof methods.

The identity sovereignty layer is therefore not merely a naming layer. It is a machine-verifiable control plane that binds authority, endpoint discovery, lifecycle continuity, privacy-preserving eligibility, and downstream issuance or communications rights to a common Identity Anchor.

### Event Intake and Canonicalization

The time sovereignty layer begins by receiving an Event Record or Behavior Record from an Authorized Source. The Event Record may include an event identifier, a subject or Identity-Anchor identifier, an activity or category identifier, a time quantity or time range, a context descriptor, anti-replay material, one or more attestations, one or more device, service-terminal, or enterprise-node identifiers, and optional metadata. Additional fields may include issuer identifiers, jurisdiction tags, resource-type tags, policy selectors, transfer restrictions, settlement hints, beneficiary tags, or other optional implementation-specific fields.

To improve reproducibility and auditability, the Event Record may be canonicalized according to deterministic normalization rules. Canonicalization may include field ordering, normalized encoding, unit normalization, timestamp normalization, removal or standardization of redundant spacing, normalization of optional-field treatment, application of taxonomy mappings, and conversion of source-specific data into a normalized intermediate form. The purpose of canonicalization is to ensure that logically equivalent event inputs produce the same or comparable commitment material for downstream proof generation and policy evaluation.

In some embodiments, the Event Record further includes an issuer identifier, one or more digital signatures or attestations, and an activity category code mapped to a recognized taxonomy. Issuer authorization may be validated by checking the issuer's inclusion in a signed Policy Bundle and by verifying issuer keys through endpoint records resolved from a Domain Basepoint or Namespace Basepoint. Thus, the system can distinguish not only whether a record is syntactically well formed, but also whether the record originated from an issuer currently authorized for the relevant category, route, or validity period.

The canonicalized Event Record may then be used to generate one or more commitments. A commitment may be derived from the canonical representation together with one or more of the Identity-Anchor identifier, a freshness token, a nonce, a sequence state, a source identifier, a policy-related discriminator, or a jurisdiction-specific context binding. In some implementations, multiple commitments are produced, such as a primary event commitment, an audit commitment, a communications commitment, and a settlement-specific provenance commitment.

Canonicalization also enables consistent audit and dispute review. When a later reviewer, dispute engine, or settlement actor recomputes a commitment from the same canonicalization rules, the later actor can verify whether the same event logically underlies a previously issued Time-Proof, Mint Certificate, or Settlement Receipt. This reduces ambiguity and makes it harder for a malicious actor to exploit formatting discrepancies, inconsistent field order, or hidden optional-field variation to obtain duplicate or conflicting issuance outcomes.

In one non-limiting workflow, an enterprise device records completion of a service event, assigns a category code, applies a time measurement, signs the event, and forwards the event to a proof-verification service. The proof-verification service canonicalizes the event, validates the issuer against a Policy Bundle, checks freshness constraints, and produces a commitment that becomes an input to a Time-Proof. In another non-limiting workflow, a subject device and an institutional node each provide partial attestations that are canonicalized into a single Event Record before proof generation. These examples illustrate that canonicalization is not limited to one data-collection model.

### Time-Proof Generation and Verification

A Time-Proof may be generated or verified using one or more commitments derived from a canonicalized Event Record. In one embodiment, the Time-Proof includes an anchor reference, a commitment, a verifiable token, signature, proof object, or equivalent evidence, replay-prevention material, a timestamp or Validity Window, and optional context-binding data. The Time-Proof may be generated by the same node that canonicalizes the Event Record or by a separate BEIProof service, institutional verifier, or distributed proof-layer node.

Verification of a Time-Proof may include resolving the namespace identifier to obtain an authoritative endpoint and corresponding credential, recomputing the commitment from canonicalized inputs, verifying a signature or proof object, checking freshness and replay-prevention constraints, checking credential status or revocation status, checking duplication or inconsistency across records, and applying category-specific, jurisdiction-specific, or institution-specific verification rules. One or more verification results may then be exposed to a policy engine as machine-readable inputs.

Replay prevention may be enforced via a state machine that tracks one or more of nonce consumption, counters, sequence state, uniqueness constraints per commitment, Validity Window constraints, and Policy-Bundle-specified rate limits. The system denies minting, routing, or other protected operations when a Time-Proof is stale, duplicated, revoked, outside the Validity Window, or inconsistent with an applicable Policy Bundle or endpoint state. In some embodiments, a consumed nonce or sequence value may be permanently recorded or committed to a Tamper-Evident Data Structure, while in other embodiments a shorter-lived freshness cache or revocation-aware state store is used.

Time-Proofs may be category-sensitive. A healthcare-related event may require issuer attestation from a recognized healthcare node, while a settlement-relevant event may require both source and counterparty attestations. A governance-related event may require policy-specific quorum indicators or threshold signatures. The architecture does not require every event to use the same proof family; instead, the Time-Proof class term encompasses multiple verifiable proof modalities so long as the proof can be checked against the applicable Identity Anchor, Validity Window, replay-prevention state, and Policy Bundle.

In one non-limiting embodiment, the system creates a proof reference from the combination of a canonical event commitment, an issuer attestation, a freshness nonce, and a time-bound signature. The proof reference is then submitted to a policy engine that verifies that the event category is eligible, that the issuer remains authorized, that issuance caps have not been exceeded, and that the requested operation falls within the active Policy Bundle version. If these conditions are satisfied, the policy engine authorizes the minting engine to perform an atomic mint-and-bind transition.

Time-Proof generation and verification thereby provide a technical bridge between raw event evidence and later issuance, communications, or settlement decisions. Rather than treating time or behavior as an unstructured claim, the system transforms the event into a machine-verifiable object with bounded temporal validity, replay resistance, and policy-aware interpretability.

### Policy Bundle and Decision Engine

A policy engine loads or verifies a signed and versioned Policy Bundle. A Policy Bundle may define Authorized Sources, eligible event categories, weighting coefficients, issuance caps, rate limits, route permissions, privacy constraints, audit permissions, exception states, beneficiary conditions, settlement permissions, institution-specific overrides, or other machine-readable rule content. In some embodiments, Policy Bundles are published with effective time windows and version identifiers such that enforcement remains deterministic across nodes, deployments, and jurisdictions.

The decision engine evaluates the canonicalized Event Record and corresponding Time-Proof against the active Policy Bundle. The evaluation may yield outcomes such as allow, allow-with-limit, hold-for-review, deny, quarantine, freeze, rollback-eligible, or beneficiary-transfer-eligible. One or more Decision Receipts are generated to record the outcome together with a policy version, rule identifier, reason code, risk score, proof reference, freshness state, or endpoint reference. These receipts may later be consumed by audit tools, settlement actors, supervisory interfaces, or dispute workflows.

In some embodiments, enforcement points include a minting engine, a routing gate, an audit verifier, a proof service, an exchange admission module, and a clearinghouse or settlement module. A single Policy Bundle may therefore govern multiple technical decision points, while still allowing endpoint roles to differ. For example, a communications endpoint may enforce a routing-eligibility subset, while a minting endpoint enforces issuance-cap and source-authorization subsets under the same versioned ruleset.

The decision engine may incorporate risk-sensitive logic. Duplicate-event detection, anomaly detection, issuer reputation, timing anomalies, issuance velocity, device consistency, or contextual inconsistency may affect whether a request is allowed, denied, or diverted to a review or quarantine state. Importantly, these risk-sensitive controls are not merely post hoc administrative notes; they are inputs to the machine-readable decision process that can be reflected in receipts and lifecycle controls.

The Policy Bundle and decision layer thus convert proof verification into deterministic operational control. This makes it possible for independent nodes to evaluate the same event/proof pair under the same versioned ruleset and reach explainable outcomes, thereby improving repeatability, auditability, and interoperability.

### Atomic Mint-and-Bind and Issuance State Transitions

Upon successful completion of event ingestion, canonicalization, proof verification, and policy evaluation, the disclosed architecture performs an atomic mint-and-bind transition. In one embodiment, the transition is executed by a minting engine operating under a signed and versioned Policy Bundle and is treated as a single logical state change for purposes of issuance integrity, auditability, and downstream settlement. The same transition creates one or more value units, associates such value units with an identity anchor, references the governing proof object, and records one or more machine-verifiable receipts that describe the reason, rule state, and provenance of the issuance decision.

Atomicity is important because the present architecture does not merely award an abstract score or update a mutable account in an opaque manner. Instead, the system binds the issuance event to a verifiable subject state. In non-limiting embodiments, the binding includes a reference to a ReadName identifier, an identity anchor, a credential state, a beneficiary restriction, a lock-period condition, or a settlement constraint. Accordingly, the issued unit is not treated as free-floating value detached from provenance, but as a technically constrained state whose origin, permissions, and lifecycle metadata remain machine-verifiable.

In some embodiments, the minting engine receives as inputs: (i) a canonicalized Event Record; (ii) a Time-Proof or equivalent proof object; (iii) an identity-anchor reference; (iv) a Policy Bundle version identifier; (v) a freshness or replay-prevention state; and (vi) one or more risk or supervisory flags. The minting engine then determines whether an allow state, allow-with-limit state, deferred-review state, deny state, quarantine state, or rollback-eligible state applies. Where the allow state is reached, the system issues a Mint Certificate. Where a deny or quarantine state is reached, the system records a Decision Receipt explaining the rule basis or safety condition that prevented completion.

The Mint Certificate may include, without limitation, a minted-unit identifier, a commitment to the source Event Record, a commitment to the governing Time-Proof, a policy version reference, an identity-anchor reference, one or more lifecycle constraints, and an issuance timestamp or validity state. In some embodiments, the Mint Certificate further records a transfer-class designation indicating whether the newly issued unit is immediately transferable, conditionally transferable, internally restricted, institutionally routed, beneficiary-gated, or settlement-pending.

The atomic mint-and-bind transition can be implemented in a smart-contract environment, a hybrid smart-contract and service orchestration environment, a permissioned ledger with deterministic workflow execution, or any equivalent computing architecture that preserves the same integrity and audit properties. The disclosure is not limited to any one chain, virtual machine, or programming environment. What matters is that issuance and binding occur as a unified transition rather than as disconnected actions that would permit provenance gaps, race conditions, or untracked post-issuance mutation.

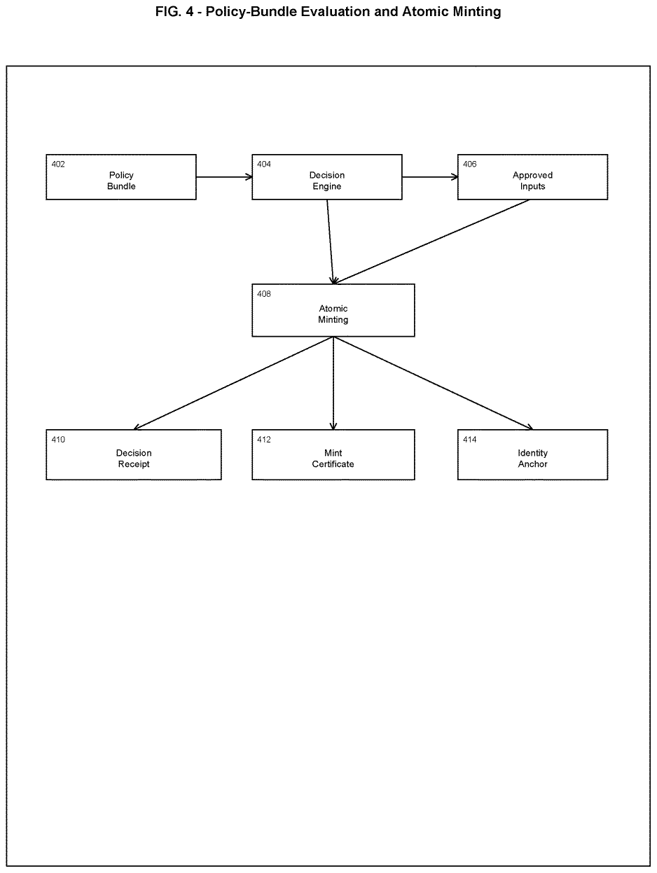

As illustrated in FIG. 4 in one embodiment, policy-bundle evaluation feeds the minting engine only after verification gates have been satisfied. The minting path therefore proceeds from validated record intake to rule application, to issuance, to receipt generation, and then to routing or settlement. This staged but atomic structure supports later enforcement, interoperability, and selective audit because each downstream step may rely on a concrete issuance artifact rather than an unverifiable assertion that some minting decision allegedly occurred.

### Tamper-Evident Commitments and Receipt Anchoring

The architecture may persist one or more commitments of a Mint Certificate, Decision Receipt, Settlement Receipt, communication-state integrity record, beneficiary-transfer receipt, or dispute-state record into a tamper-evident data structure. The role of the tamper-evident structure is not merely archival. It functions as an integrity substrate from which provenance, ordering, lifecycle history, and non-repudiation can be checked by authorized services and, in some embodiments, by independent counterparties or institutional adapters.

A Tamper-Evident Data Structure may be implemented as a distributed ledger, permissioned ledger, append-only log, Merkle-based commitment log, write-once-read-many storage, hybrid on-chain and off-chain commitment structure, or other integrity-preserving arrangement. Detailed records may remain encrypted or off-chain while commitments, hashes, proofs, receipt references, revocation states, and audit anchors are recorded in a structure that permits later verification without disclosing protected underlying content.

In one non-limiting embodiment, the receipt anchoring process comprises: generating a receipt object; canonicalizing the receipt object or selected fields thereof; hashing or otherwise committing the canonicalized receipt; writing the commitment to a tamper-evident structure; and associating the resulting anchor reference with one or more service endpoints or audit endpoints. In this way, the system can prove that a particular issuance, routing, settlement, inheritance, or rollback state existed and was recorded at a given point in the lifecycle, even when certain sensitive payload elements remain confidential.

Receipt anchoring may be performed synchronously with issuance or asynchronously according to system design. In some embodiments, the minting transition itself emits the receipt commitment. In other embodiments, a receipt service or anchoring service later receives a receipt object, validates it, and writes the commitment to an integrity-preserving log. The disclosure contemplates both direct and mediated anchoring, provided that an auditable relationship is preserved between the operative state and the recorded commitment.

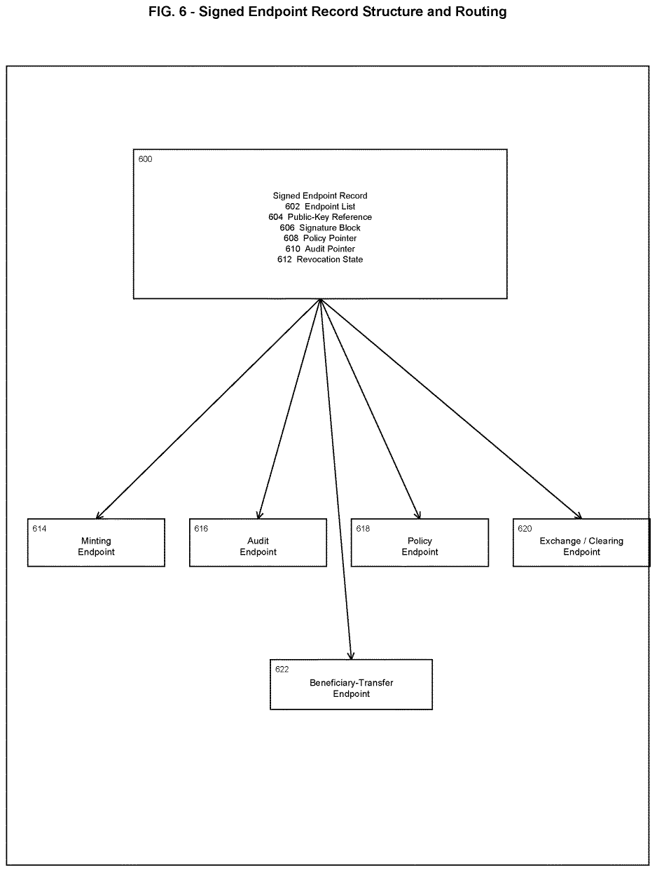

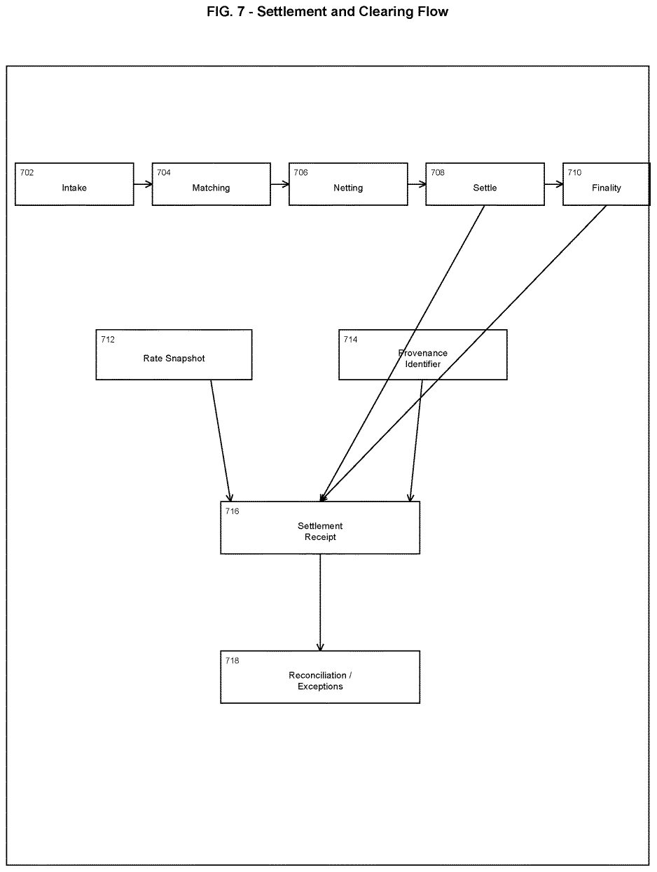

FIG. 6 and FIG. 7 may be understood as illustrating non-limiting ways in which routing, settlement, and finality states are connected to receipts. For example, a settlement workflow can produce a Settlement Receipt whose commitment is anchored to a distributed or permissioned ledger, while the detailed settlement payload remains encrypted or is routed to an institutional endpoint. Similarly, a communications event may yield a communication-state integrity record that proves authorized routing or session initiation without exposing message content.

The use of anchored receipt commitments improves system resilience against hidden mutation, retroactive rewriting, inconsistent counterparty logs, and unverifiable exception handling. It also strengthens later licensing and interoperability value because external systems can be adapted to consume or validate receipt commitments without requiring full internal implementation of every subsystem described herein.

### Signed Endpoint Routing and Service Discovery

The disclosed architecture employs Signed Endpoint Routing to identify authoritative services for identity resolution, proof verification, policy retrieval, audit export, minting, exchange, clearing, settlement, analytics, inheritance, beneficiary transfer, and other role-specific operations. In one embodiment, a Domain Basepoint or Namespace Basepoint resolves to one or more Signed Endpoint Records, each of which specifies an endpoint role, a route or service URI, a public-key reference, a policy pointer, a revocation pointer, an interface version, a validity window, and an optional jurisdiction tag or audit pointer.

Signed Endpoint Routing permits the system to operate as a federated but technically coherent fabric. Rather than hard-coding all protocol locations or depending upon mutable platform-specific account identifiers, the system resolves a human-readable or machine-stable namespace to authoritative service endpoints whose authenticity and current validity can be verified. This architecture is particularly useful where identity, minting, proof verification, communications, settlement, and institution-facing adapters are deployed by different operators but must remain interoperable under common policy semantics.

Service discovery may be hierarchical. A parent basepoint may indicate a root policy endpoint or discovery service, while sub-basepoints or role-specific routes identify minting, proof, vault, exchange, audit, or communications functions. In some embodiments, multiple Signed Endpoint Records may coexist for the same namespace so that different service roles, versions, jurisdictions, or fallback routes can be selected without changing the subject's primary identity anchor.

Before endpoint use, the system may authenticate the Signed Endpoint Record by verifying signature validity, checking the current revocation state, confirming the validity window, and evaluating whether the endpoint role and jurisdiction tag are consistent with the requested operation and applicable Policy Bundle. This is not merely directory look-up. It is authenticated routing with policy-aware service discovery. If the endpoint record is stale, revoked, mismatched, or inconsistent with current policy state, the requested operation may be denied, deferred, or rerouted according to enumerated fallback rules.

In one non-limiting use case, a minting engine resolves a namespace to a proof-verification endpoint, a policy endpoint, and a settlement endpoint. In another use case, a communications service resolves a namespace-linked identity anchor to a RedName session-initiation endpoint and to a separate audit endpoint that stores only non-sensitive session integrity records. In still another use case, an inheritance service resolves the same basepoint to a beneficiary-transfer endpoint whose validity becomes active only upon defined trigger conditions. These examples show that Signed Endpoint Routing supports both modularity and lifecycle control.

As illustrated in FIG. 6, a Signed Endpoint Record is also a technical bridge between internal protocol objects and later claims concerning interoperability, institutional adapters, and external rails. By placing endpoint roles, policy pointers, interface versions, and audit pointers in a signed and verifiable object, the architecture creates a concrete routing mechanism that can later support differentiated implementations without abandoning common verification semantics.

### Numberless Secure Communications and RedName Operation

The communications layer of the present disclosure establishes encrypted communications channels without requiring telephone-number addressing or SIM-based addressing identifiers. In one embodiment, a RedName communications module derives or resolves a communications endpoint from a namespace-linked identity anchor. The resulting endpoint is then authenticated via one or more Signed Endpoint Records and used to establish a session whose permissions, routing conditions, and integrity controls are evaluated under a current policy state.

A numberless communication workflow may comprise: resolving or deriving a communications endpoint from a namespace-linked identity anchor; authenticating a Signed Endpoint Record including freshness state and revocation status; performing key-agreement or session-authentication operations; applying a policy gate to determine whether session initiation, endpoint exposure, routing, or message delivery is permitted; and, upon success, establishing an encrypted session and recording a non-sensitive communication-state integrity record or receipt. This workflow provides a concrete technical path from namespace resolution to secure session establishment.

In some embodiments, the RedName layer supports ephemeral addressing. An endpoint identifier may be derived using a nonce, a time-dependent value, a session-specific value, a proof-linked value, or another freshness component so that static exposure of communications routes can be reduced. The system may also limit endpoint disclosure to authorized counterparties or to policy-approved service roles. Thus, a subject's namespace-linked identity anchor need not expose a permanent public address for all communications operations.

Metadata minimization may be applied at one or more stages of the communications lifecycle. For example, route discovery may reveal only the endpoint necessary to perform a requested role, rather than a full list of service routes. Session records may store only commitment references, timestamps, policy identifiers, or integrity anchors instead of message content. Audit services may receive proof that a session was established or that a routing condition was satisfied without obtaining underlying payload data. These features allow the communications subsystem to support supervision and compliance without collapsing into content surveillance.

The disclosure further contemplates that communications permissions may depend on identity status, revocation state, beneficiary state, institutional-adapter rules, or time-bound policy conditions. Thus, communications are not treated as a separate unrelated feature but as a lifecycle-controlled extension of the same identity, proof, and policy architecture used for minting, settlement, and inheritance. This integration is one reason the present system is more than a mere messaging platform and more than a mere token system.

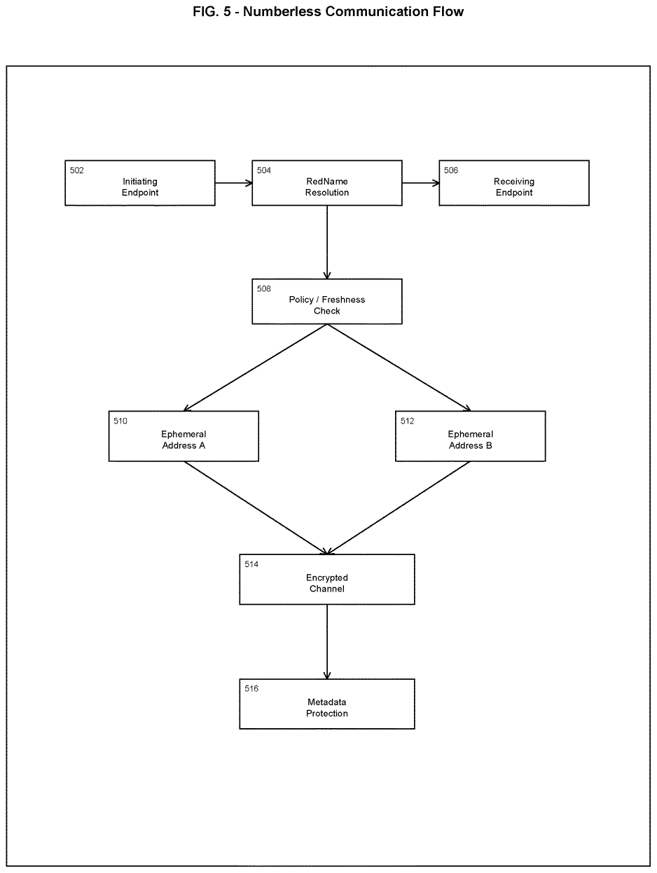

FIG. 5 may be understood as illustrating the technical path by which an authenticated endpoint is derived or resolved, a session is admitted, and policy-bounded routing proceeds. In some embodiments, failure states are also recorded, such as stale endpoint state, revoked endpoint state, policy-denied routing, failed key validation, or failed communication-state integrity. Such records can later be used for selective audit, dispute analysis, or safety control.

### Privacy-Preserving Presentations and Selective Audit

The present disclosure supports privacy-preserving presentations that prove satisfaction of one or more conditions without revealing unnecessary protected information. Such presentations may be used in identity operations, proof verification, communications routing, settlement admission, inheritance triggers, audit workflows, and compliance checks. In non-limiting embodiments, the system may employ selective disclosure, verifiable credentials, zero-knowledge techniques, blinded commitments, encrypted attestations, threshold attestations, or other privacy-preserving methods consistent with the claims and embodiments described herein.

A privacy-preserving presentation may prove, for example, that an Event Record came from an Authorized Source; that a subject belongs to an eligible category; that a Time-Proof is within an applicable validity window; that an endpoint role satisfies an admission rule; that a beneficiary trigger has occurred; or that a settlement instruction satisfied defined policy constraints. The verifier need not always receive the underlying sensitive event details, medical records, full credentials, or confidential institutional routing data.

Selective audit is an important complementary function. In one embodiment, an audit verifier receives a proof object, one or more receipt commitments, and a policy version reference. The audit verifier may then confirm that a required control state was satisfied, such as policy conformance, endpoint authenticity, finality status, or bounded rollback eligibility, without being given access to the full underlying payload. In another embodiment, a supervisory node receives only non-sensitive metadata together with references sufficient to support later escalated review if authorized.

The combination of privacy-preserving presentations and selective audit allows the architecture to operate across commercial, institutional, public-interest, and sovereignty-oriented contexts in which privacy and accountability must coexist. This is especially important where the architecture is used for healthcare records, judicial evidence handling, treaty or carbon compliance, inter-organizational settlement, or beneficiary-transfer workflows, each of which may require different disclosure thresholds but still depend upon common proof and receipt semantics.

In some embodiments, a BEIProof proof-layer service acts as an operational component that issues, verifies, or audits proof artifacts while remaining separable from the minting or communication payloads. Such a service may expose proof issuance endpoints, proof verification endpoints, proof-policy retrieval endpoints, or proof-audit endpoints, all discoverable through Signed Endpoint Routing. This arrangement improves modularity and supports later licensing, deployment, and institutional adaptation without changing the core integrity architecture.

### Risk Controls, Anti-Fraud, and Sybil Resistance

The architecture includes safety controls and anti-fraud logic that operate before, during, and after protected state transitions. In one embodiment, the system computes one or more risk scores using duplicate-event detection, anomaly detection, issuance velocity checks, device-consistency checks, issuer-integrity status, behavioral-density analysis, temporal inconsistency checks, geographic inconsistency checks, or policy-threshold rules. Such controls may be applied to event acceptance, proof validation, endpoint use, communications admission, settlement, or beneficiary transfer.

Sybil resistance may be achieved through a combination of identity-anchor integrity, Authorized Source validation, replay-prevention state, policy-governed issuance caps, route authentication, and receipt-based auditability. The architecture does not rely on a single simplistic anti-Sybil mechanism. Instead, it treats Sybil risk as a multi-factor problem involving subject identity, source integrity, timing patterns, endpoint authenticity, and state-transition density across the ledger or integrity substrate.

Fraud-handling outcomes may include deny, hold-for-review, quarantine, freeze, rate-limit, reduce-cap, require-additional-verification, route-to-supervisory-review, or mark-as-rollback-eligible. In some embodiments, a risk-scoring subsystem records which rule identifiers, anomaly detectors, or supervisory overrides contributed to a non-allow state, and this information may then be reflected in a Decision Receipt. Such recordation can be helpful both for internal governance and for external audit or dispute handling.

Risk controls may also operate at the institutional-adapter or external-rail boundary. For example, an adapter might require elevated proof quality, stricter validity windows, or a specific endpoint role before allowing settlement instructions to leave the internal environment. Similarly, a communications session might be denied or narrowed if a revocation signal or a stale endpoint state appears during session establishment. These examples show that safety logic is not limited to minting alone but applies across the lifecycle of identity, routing, communications, and settlement.

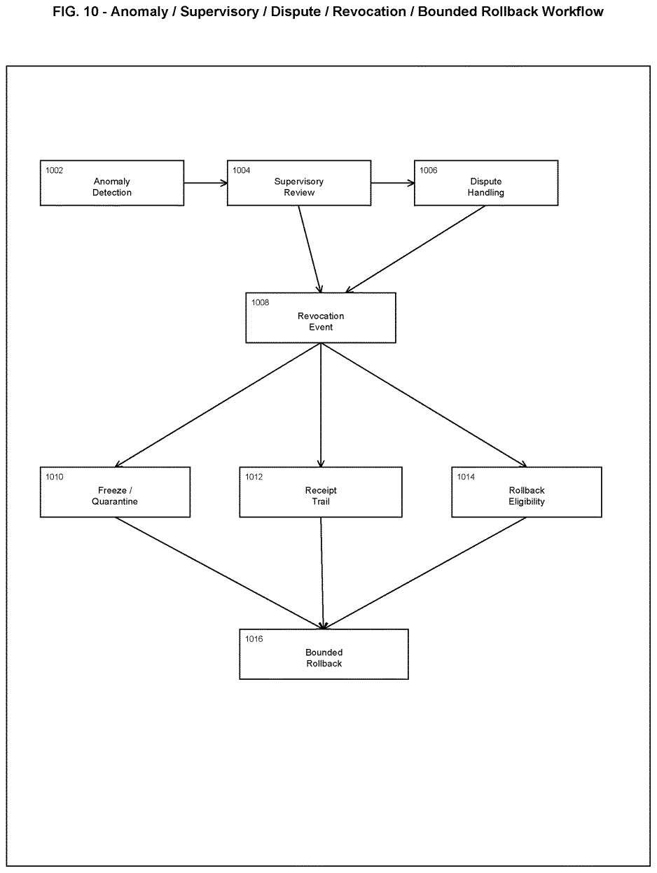

As illustrated conceptually in FIG. 10, the system may move from anomaly detection to supervisory review, dispute handling, revocation, or bounded rollback according to defined policy states. This multi-stage safety posture improves reliability while preserving machine-verifiable accountability. It also strengthens the long-term transaction and licensing value of the system because commercial and institutional adopters generally require clear technical narratives for fraud handling, exception management, and controlled reversibility.

### Settlement, Exchange, Clearing, and Finality

In some embodiments, the value units issued by the minting engine may be transferred, converted, exchanged, netted, settled, mirrored to another rail, or otherwise transformed under policy control. The settlement layer is not limited to a simple transfer between two balances. Rather, it contemplates a broader workflow in which endpoint discovery, permission checks, proof validation, rate determination, reconciliation, and finality state management occur as coordinated steps.

A settlement workflow may include resolving one or more Signed Endpoint Records for exchange, clearing, or settlement services; verifying whether the transfer or conversion is permitted under the current Policy Bundle; obtaining a rate snapshot or transformation parameter; validating provenance or restriction state of the units to be settled; generating a settlement instruction; executing an atomic commit, netting, or rollback-capable transition; and generating a Settlement Receipt. The Settlement Receipt may include a settlement identifier, finality state, provenance reference, counterparty reference, timestamp, rate snapshot, and optional reconciliation state.

Finality may be expressed as, for example, committed, pending-confirmation, rolled-back, awaiting-netting, reconciled, partially-settled, or another state appropriate to a given implementation. Importantly, finality is not treated as an external legal assumption but as a machine-trackable condition that can be referenced by audit services, beneficiary services, dispute-handling services, and external adapters. Thus, the system can preserve an explicit lifecycle record of value-unit movement from issuance through final settlement or reversal.

Clearing may be bilateral, multilateral, institutional, or community-governed. The architecture permits centralized or decentralized clearinghouse semantics, provided that the relevant endpoints, proof requirements, policy windows, and receipt semantics are honored. In one embodiment, a clearinghouse service receives multiple settlement instructions, matches or nets them according to policy and timing rules, and emits clearing receipts or reconciliation receipts that are then anchored into a tamper-evident structure.

Interoperability Mapping may translate internal messages, receipts, settlement instructions, or related protocol objects into standardized external formats or adapter interfaces for external rails. Examples include payment-versus-payment flows, delivery-versus-payment flows, institutional ledger postings, token-to-record transformations, or compliance export messages. The present disclosure does not depend upon one external standard, but instead discloses a mapping layer by which internal protocol semantics can be exported without abandoning the system's own proof, receipt, and lifecycle controls.

FIG. 7 may be understood as illustrating a non-limiting settlement pathway in which issuance provenance, endpoint discovery, exchange or clearing logic, and finality state are all treated as interdependent technical states rather than as disconnected bookkeeping. This approach is valuable for both patentability and real-world deployment because it gives the system a concrete, technically coherent path from minted value to verified finality.

### Institutional Adapters and External Rails

The architecture may expose one or more Institutional Adapters that allow internal identity, proof, minting, communication, and settlement states to interact with external systems without requiring the core protocol semantics to be abandoned. An Institutional Adapter may be implemented as a gateway, translator, supervised node, trusted execution environment, messaging adapter, clearing interface, regulatory export interface, or other service that consumes internal protocol objects and produces institution-compatible outputs, or vice versa.

Institutional Adapters may enforce elevated requirements such as stricter proof verification, shorter validity windows, jurisdiction-specific routing constraints, sanctioned endpoint lists, multi-signature approvals, settlement caps, or standardized message schemas. The adapter need not replicate the full internal architecture, but it preferably preserves the machine-verifiable link among the identity anchor, proof state, policy version, endpoint authenticity, and finality record associated with a transaction or communications event.

By separating institutional adaptation from core semantics, the disclosure creates a flexible deployment model. A sovereignty-oriented deployment can operate primarily through internal basepoints, receipts, and policy bundles, while an institution-facing deployment can add export, compliance, reconciliation, or reserve-management logic through adapters discovered via Signed Endpoint Routing. This allows the same underlying architecture to serve individual, community, enterprise, and institution-facing use cases without fragmenting the proof and receipt model.

External rails may include, without limitation, payment rails, clearing rails, ledger interfaces, enterprise settlement systems, supervisory reporting channels, benefit-disbursement systems, vault or custody systems, and other interoperable infrastructures. The disclosure is not limited to any one external rail. Instead, it describes how internal objects such as Mint Certificates, Settlement Receipts, and policy-verified endpoint instructions may be mapped or transformed in a technically controlled manner.

The existence of Institutional Adapters also increases licensing and transfer value because adopters may implement adapter layers tailored to their own infrastructure while relying upon the same core patent-supported architecture for identity anchors, proof processing, receipts, routing, and lifecycle control. In this respect, the architecture is scalable not merely in transaction volume but in institutional compatibility.

### Inheritance, Beneficiary Transfer, and Succession Controls

The present disclosure further contemplates inheritance, beneficiary transfer, and succession controls applicable to identity-linked credentials, controlled references, vault states, communication permissions, and value-unit rights. These lifecycle controls are not treated as afterthoughts. They are integrated into the same identity-anchor, proof, policy, endpoint, and receipt architecture used elsewhere in the system. Accordingly, inheritance events may be triggered and verified in a manner that remains auditable, privacy-preserving, and consistent with policy-defined restrictions.

In one embodiment, an inheritance engine stores one or more beneficiary designations, trigger conditions, waiting periods, succession rules, dispute windows, jurisdiction-specific controls, or multi-signature requirements in connection with an identity anchor or ReadVault data structure. A trigger may be based on an external attestation, a proof object, an administrative event, a supervisory authorization, a time-based condition, or a combination thereof. Upon satisfaction of applicable conditions, the system may activate or transfer one or more rights, credentials, balances, access states, or routing permissions to a beneficiary or successor state.

Beneficiary transfer need not mean full immediate transfer of all associated system states. In some embodiments, communications permissions may transfer differently from value rights; audit rights may transfer differently from issuance permissions; or a vault may expose only a limited disclosure package until higher-level succession conditions are satisfied. The architecture therefore supports granular succession rather than requiring a binary all-or-nothing transfer model.

Each inheritance or beneficiary-transfer event may generate a beneficiary-transfer receipt, succession receipt, or related lifecycle record. Such a record may be anchored in a tamper-evident structure and may reference the applicable trigger state, policy version, beneficiary identifier, dispute window, and scope of transferred control. Selective audit and privacy-preserving presentations may be employed so that the system can prove that transfer conditions were satisfied without publicly disclosing sensitive personal or estate information.

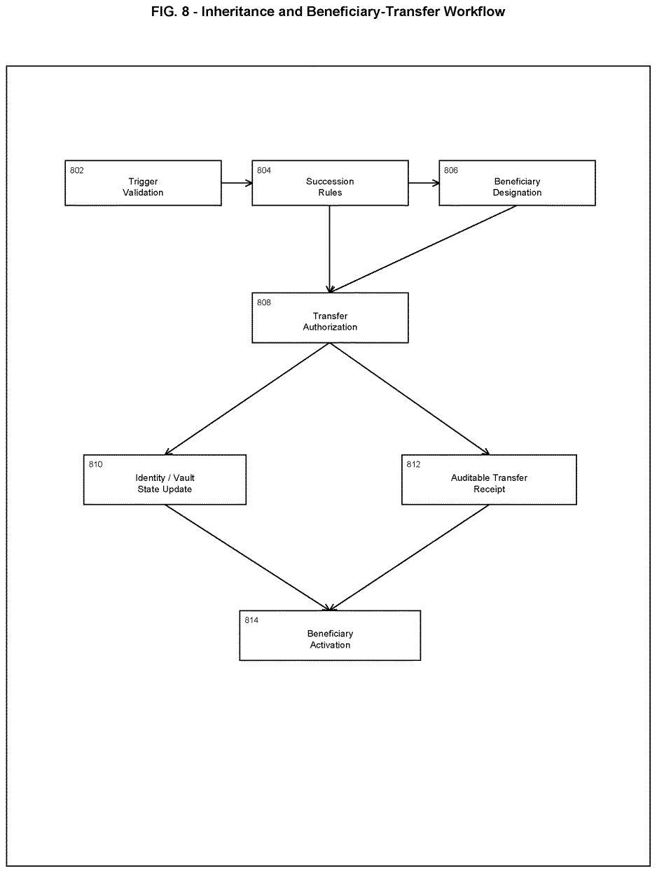

FIG. 8 conceptually illustrates an inheritance and beneficiary-transfer workflow in which trigger validation, succession evaluation, beneficiary determination, and auditable receipt generation are coordinated through Signed Endpoint Routing and common receipt semantics. This unified treatment of succession improves both practical deployment and patent strength because it places inheritance within the same technical lifecycle framework as identity verification, minting, communications, and settlement.

### Dispute, Revocation, and Bounded Rollback

The architecture includes dispute, revocation, and bounded rollback controls that preserve auditability while preventing uncontrolled retroactive mutation. A dispute may arise from proof-quality concerns, source-integrity concerns, communications-routing challenges, settlement inconsistency, alleged beneficiary error, policy mismatch, or other enumerated exceptions. Revocation may arise from credential compromise, endpoint compromise, source de-authorization, policy-state invalidation, or the expiration or supersession of an applicable state.

Bounded rollback is not an unrestricted administrator power. Instead, it is a technically constrained corrective mechanism governed by explicit state rules, temporal boundaries, quantitative boundaries, proof requirements, or supervisory conditions. In some embodiments, bounded rollback may reverse an unfinalized or conditionally final state, freeze a unit pending investigation, restore a prior permission state, or mark a settlement as rolled-back, but only if the applicable Policy Bundle and lifecycle constraints permit such action.

A rollback workflow may include: identifying a challenged state transition; resolving the relevant proof, policy, endpoint, and receipt references; verifying whether rollback eligibility exists under a current or historically applicable Policy Bundle; generating a rollback instruction or dispute-state record; executing a bounded reversal or freeze; and producing a corresponding receipt or integrity anchor. In one embodiment, the rollback operation does not create net new value beyond policy constraints and does not erase the evidentiary trail of the challenged transition.

Revocation may be propagated through Signed Endpoint Routing and associated revocation pointers so that stale or compromised endpoints, credentials, or source authorizations are not unknowingly reused. Similarly, dispute-state markers may be exposed to authorized services to prevent downstream settlement or beneficiary transfer while a challenge is unresolved. These mechanisms allow the system to remain technically coherent even under adverse conditions.

The combined use of dispute records, revocation signals, rollback limits, and anchored receipts allows the system to support safety and correction without devolving into opaque discretionary editing. This is an important feature for patentability, licensing, and deployment because it shows a concrete technical method of preserving integrity and lifecycle accountability in the face of exceptions rather than merely asserting that exceptions can be handled somehow.

The foregoing embodiments are illustrative and non-limiting. Features described in one embodiment may be combined with features described in another embodiment unless clearly incompatible. The order of operations, distribution of services, selection of data structures, and degree of centralization or decentralization may vary while remaining within the scope of the present disclosure.

### Sector Embodiments and Domain-Specific Overlays

The disclosed sovereignty architecture may be instantiated in a variety of sector-specific overlays without departing from the core technical fabric described herein. In such overlays, the same identity-anchor, proof, policy, routing, issuance, receipt, and settlement semantics are preserved, while category-specific data models, policy bundles, endpoint roles, and supervisory constraints are layered onto the common framework.

Sector embodiments are important because they demonstrate that the architecture is not limited to a single narrow application and may be deployed in different technical environments while maintaining the same machine-verifiable control structure. The embodiments below are non-limiting and are included to provide written-description support, enablement support, claim interpretation support, and modular expansion support.

### Healthcare Identity, Proof, and Audit Overlay

In a healthcare overlay, a patient, provider, facility, device, laboratory, pharmacy, payer, or auditor may each correspond to one or more namespace-linked identity anchors. An Authorized Source may include, without limitation, a licensed clinician terminal, hospital information system, diagnostic device, laboratory gateway, prescription service, or institutional adapter connected to a provider network. A healthcare Behavior Record may represent diagnosis events, triage events, treatment events, medication-administration events, chain-of-custody events for specimens, consent events, discharge events, or wellness-compliance events.

A healthcare Time-Proof may bind one or more of: a patient-linked event identifier, provider identity, device attestation, care interval, clinical category, and consent state to a validity window and replay-prevention state. Policy Bundles in this sector may define source authorization rules, privacy constraints, jurisdiction-specific disclosure constraints, emergency override logic, reimbursement categories, audit permissions, retention periods, and routing rules for institutional adapters or supervisory endpoints.

In one embodiment, a treatment authorization flow comprises: creating a patient-linked identity anchor; resolving provider and payer endpoints through Signed Endpoint Records; ingesting a treatment-related Event Record from an Authorized Source; generating or verifying a Time-Proof; evaluating payer and facility policy bundles; issuing one or more Decision Receipts and, where permitted, one or more value-linked units or coverage-state updates; anchoring corresponding receipts in a Tamper-Evident Data Structure; and making a privacy-preserving presentation available to an auditor or payer without disclosing unnecessary protected health information.

The healthcare overlay may further support prescription provenance, device telemetry attestation, adverse-event investigation, prior-authorization routing, provider accountability scoring, and controlled beneficiary-transfer or inheritance rules for long-term care authorizations, custodial rights, or patient-directed access grants. These functions remain anchored in the same common proof-and-routing framework described elsewhere in this disclosure.

### Judicial, Evidence, and Case-Lifecycle Overlay

In a judicial or evidentiary overlay, a party, witness, court clerk, tribunal, evidence custodian, investigator, mediator, or external institution may be modeled as an identity anchor or as an endpoint role reachable through a Signed Endpoint Record. Event Records may represent evidence intake, custody transfer, filing events, hearing attendance, compliance steps, notice delivery, sanctions triggers, or adjudicative outcomes.

A judicial Time-Proof may be used to bind an evidentiary object, filing package, or procedural event to an identity anchor, timestamp, validity window, and anti-replay state such that later review can confirm provenance, chain-of-custody integrity, filing timeliness, and policy compliance. Policy Bundles may encode sealing rules, access controls, service windows, retention periods, privilege constraints, routing priorities, and adjudicative review permissions.

In one non-limiting embodiment, evidence intake comprises: receipt of a custody-linked Event Record; canonicalization of associated metadata and integrity commitments; issuance or verification of a Time-Proof; generation of one or more Decision Receipts identifying handling rules, chain-of-custody states, or access restrictions; storage of detailed records in encrypted or restricted repositories; anchoring of commitments in a Tamper-Evident Data Structure; and controlled exposure of endpoint-authenticated references to adjudicative or review nodes.

This overlay may additionally support automated proof of filing timeliness, privacy-preserving proof of service, policy-gated release of evidentiary subsets, dispute-triggered rollback of administrative states, or beneficiary-transfer-like succession logic for long-duration record stewardship. The same foundational architecture therefore supports trusted evidence handling and judicial process integrity without reliance on a single centralized case database.

### Carbon, Treaty, and Compliance Overlay

A carbon, treaty, or compliance overlay may use the disclosed architecture to represent emissions measurements, mitigation events, reporting events, inspection events, treaty obligations, offset issuance, reconciliation events, and supervisory interventions. Authorized Sources may include meter gateways, environmental sensors, enterprise reporting systems, validator institutions, public registries, or institutional adapters for external compliance rails.

In one embodiment, a compliance-linked Event Record includes a source identifier, category code, quantity or interval information, geographic or facility tag, and one or more supporting commitments. A Time-Proof may bind the event to a validity window and to source-integrity constraints so that stale, duplicate, or revoked submissions can be rejected. Policy Bundles may define eligible reporting categories, quality thresholds, allowable validation paths, jurisdictional treatment, conversion rules, and settlement semantics.

Where a carbon-credit or treaty-compliance state transition is permitted, the architecture may generate a Decision Receipt, a Mint Certificate or equivalent compliance-state certificate, and, where settlement or exchange occurs, a Settlement Receipt linked to finality states and interoperability mappings. Clearinghouse nodes, registry adapters, or treaty-monitoring institutions may consume privacy-preserving proofs and endpoint-authenticated instructions without requiring full disclosure of all underlying source data.

This overlay also supports audit trails for inspection findings, corrective-action obligations, exception handling, bounded rollback of provisional states, and structured reconciliation among multiple institutional participants. Because the same receipt and routing semantics are reused, sector-specific adaptation does not require reinvention of the underlying identity-proof-policy-settlement fabric.

### Governance, Economic Node, and Institutional-Adapter Overlay

The disclosed architecture may also be deployed as a governance, economic-node, or institutional-adapter overlay. An Economic Node may represent a community, enterprise, program, network participant, or jurisdiction-scoped operating cell that consumes the common proof, routing, settlement, and lifecycle-control semantics of the mother architecture.

In one embodiment, an Economic Node maintains one or more role-based endpoints for policy publication, audit verification, proof verification, issuance review, settlement, beneficiary processing, and supervisory intervention. Institutional Adapters may bridge internal protocol objects to legacy or external systems while preserving endpoint authentication, receipt semantics, policy enforcement, and finality logic.

A governance overlay may therefore support on-chain or off-chain voting inputs, contribution-linked issuance policies, time-linked service recognition, delegated authority, beneficiary restrictions, multi-party approvals, and audited policy publication, while still maintaining a common identity-anchor and proof fabric.

This overlay is particularly suitable for implementations involving communities, enterprises, regional systems, fund structures, or collaborative programmatic networks, because it allows distinct nodes to operate under tailored policy bundles without fragmenting the common verifiability model.

### Analytics, Monitoring, and Supervisory Intelligence

The architecture may include analytics, monitoring, and supervisory-intelligence subsystems configured to consume canonicalized Event Records, Time-Proofs, Decision Receipts, Settlement Receipts, communication-state integrity records, endpoint-health records, and policy-state updates. Such subsystems may be distributed, role-limited, privacy-preserving, or institution-specific.

Analytics functions may include, without limitation: anomaly detection, duplicate-event detection, issuance-velocity monitoring, behavioral-density monitoring, endpoint-health monitoring, revocation propagation monitoring, clearing backlog detection, settlement finality monitoring, compliance-window monitoring, and beneficiary-trigger evaluation. Monitoring outputs may be represented as structured records, alerts, dashboards, supervisory receipts, or policy-update recommendations.

In one embodiment, a supervisory module periodically evaluates event patterns across identity anchors, endpoint roles, geographies, or institutions and computes one or more indicators of source trustworthiness, policy-drift, Sybil-like behavior, suspicious repetition, routing anomalies, settlement congestion, or unexplained state transitions. The outputs of such monitoring may feed into risk scoring, additional verification triggers, rate limits, freeze states, quarantine states, or bounded rollback workflows.

A monitoring subsystem may operate over detailed records, commitment-only views, or privacy-preserving proofs, depending on permissions and deployment requirements. Accordingly, analytics need not require full disclosure of all underlying sensitive content. Monitoring and supervisory functions may themselves be auditable, versioned, and constrained by policy bundles with effective time windows.

The disclosed monitoring architecture therefore improves technical resilience and governance observability without collapsing the system back into a fully centralized trust model.

### Figure-by-Figure Worked Embodiments

The figures described in this disclosure may be understood as non-limiting worked embodiments of the architecture and are intended to assist a reader, examiner, implementer, or future licensee in understanding how the defined technical objects may cooperate in practice. The descriptions below do not limit the invention to the exact order, labeling, or partitioning shown in any figure.

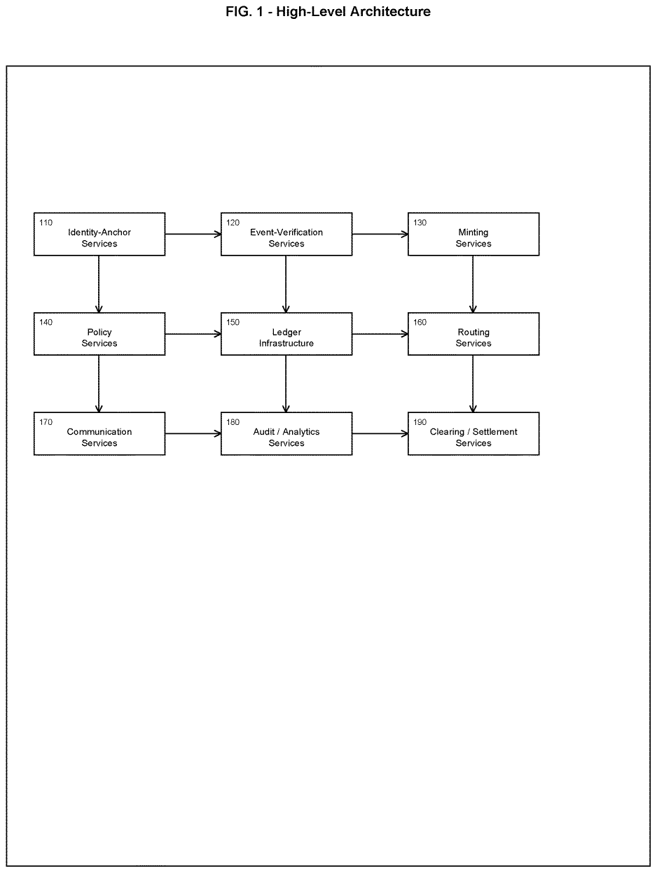

### FIG. 1—High-Level Architecture

FIG. 1 may be understood as illustrating a high-level arrangement in which identity-anchor services, proof-generation or verification services, policy services, minting services, communications services, audit services, settlement services, and supporting infrastructure cooperate through Signed Endpoint Records and common receipt semantics.

In one embodiment, a user or source-facing client device communicates with one or more gateway or service endpoints. The architecture separates concerns across identity resolution, proof processing, policy evaluation, issuance, communications, and settlement while preserving common routing and lifecycle rules.

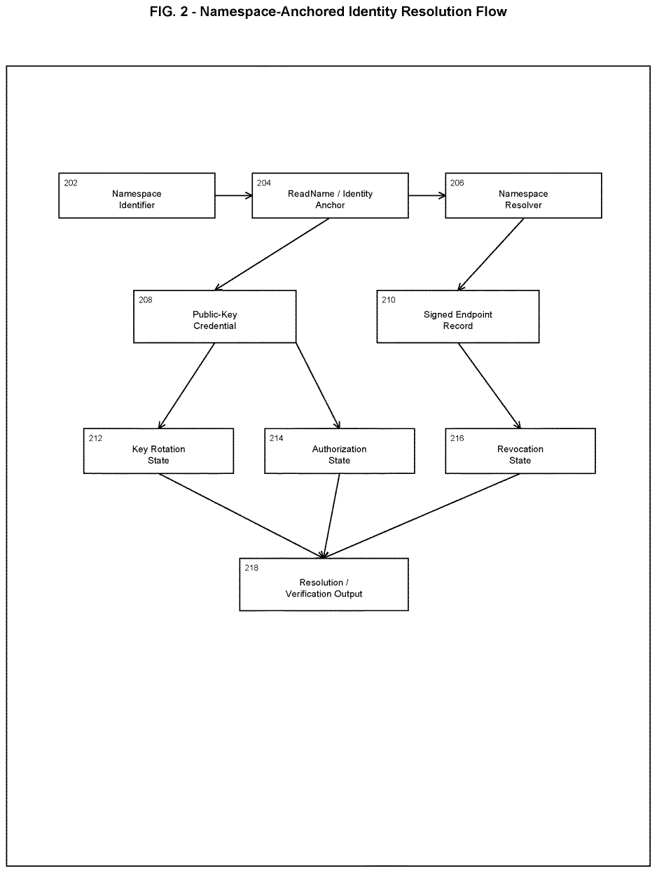

### FIG. 2—Namespace-Anchored Identity Resolution Flow

FIG. 2 may be understood as illustrating creation or resolution of a ReadName or other namespace-linked identifier to an identity anchor and one or more Signed Endpoint Records. The flow may include key establishment, credential linkage, revocation-state retrieval, policy-pointer retrieval, and endpoint-role discovery.

In one embodiment, parent and child basepoints cooperate such that different service roles may be discovered under a consistent namespace fabric.

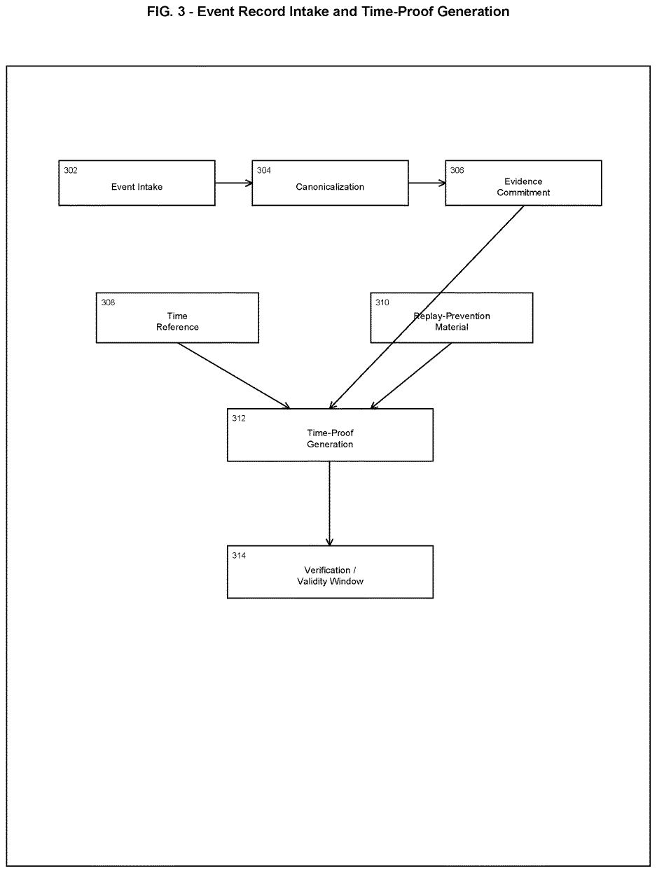

### FIG. 3—Event Record Intake and Time-Proof Generation

FIG. 3 may be understood as illustrating intake of an Event Record from an Authorized Source, canonicalization of fields, generation of a commitment, and issuance or verification of a Time-Proof having a validity window and replay-prevention state.

This figure may also be understood as showing that event acceptance depends on source authorization, canonical integrity, freshness, and anti-replay checks rather than on mere self-reporting.

### FIG. 4—Policy Evaluation and Atomic Minting

FIG. 4 may be understood as illustrating how a signed and versioned Policy Bundle is applied to a verified Event Record and Time-Proof before a minting engine executes a single atomic mint-and-bind transition. The resulting outputs may include a Mint Certificate and one or more Decision Receipts.

In one embodiment, no issuance state is committed until verification gates and policy conditions are satisfied.

### FIG. 5—Numberless Communication Flow

FIG. 5 may be understood as illustrating derivation or resolution of communications endpoints without telephone-number addressing, followed by endpoint authentication, policy gating, session establishment, and communication-state integrity recording.

The figure further demonstrates that endpoint freshness, revocation status, and routing permissions may be checked before message delivery or endpoint exposure.

### FIG. 6—Signed Endpoint Record Structure and Routing

FIG. 6 may be understood as illustrating one non-limiting representation of a Signed Endpoint Record, including a basepoint identifier, endpoint role, service URI or route, public-key reference, policy pointer, revocation pointer, interface version, validity window, jurisdiction tag, and audit pointer.

This figure helps show that routing is not based on ad hoc address strings alone, but on authenticated, policy-aware routing objects.

### FIG. 7—Settlement and Clearing Flow

FIG. 7 may be understood as illustrating endpoint-authenticated instructions for exchange, clearing, reconciliation, and settlement, together with rate snapshots, provenance references, finality states, and Settlement Receipts.

In one embodiment, the flow may support committed, rolled-back, or pending-confirmation states depending on policy, counterparties, and adapter outcomes.

### FIG. 8—Inheritance and Beneficiary-Transfer Workflow

FIG. 8 may be understood as illustrating how inheritance triggers, beneficiary designations, policy restrictions, waiting periods, or multi-signature conditions may govern transfer of rights, credentials, vault references, balances, or controlled states.

This figure makes clear that inheritance handling is not a merely narrative add-on but a technically governed lifecycle module.

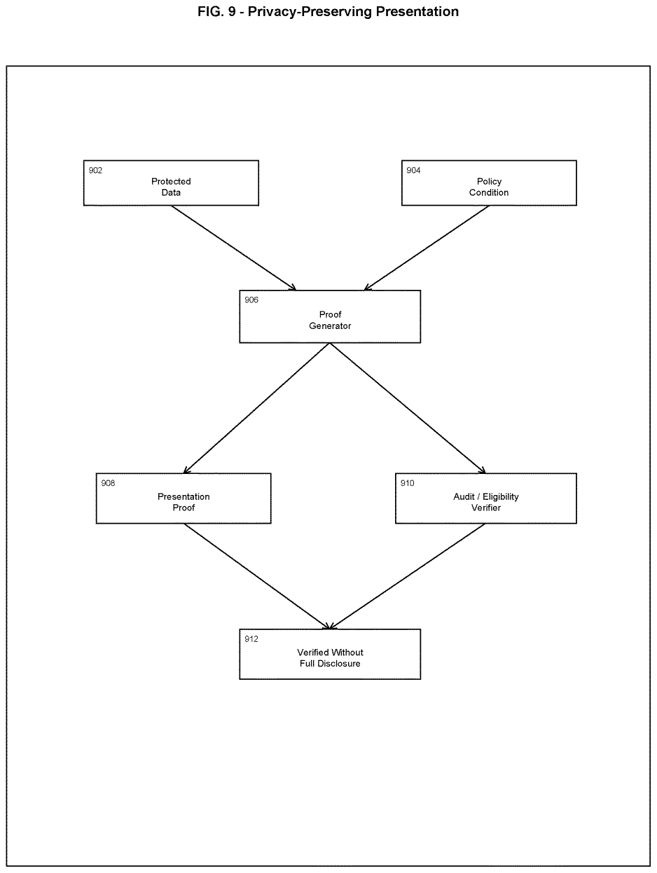

### FIG. 9—Privacy-Preserving Presentation

FIG. 9 may be understood as illustrating generation and verification of privacy-preserving presentations proving satisfaction of eligibility, category, threshold, entitlement, or source-authorization conditions without revealing unnecessary sensitive data.

In one embodiment, only proof metadata, commitments, or hashed receipt references are exposed to a verifier.

### FIG. 10—Anomaly, Supervisory Review, Dispute, Revocation, and Bounded Rollback

FIG. 10 may be understood as illustrating detection of anomalous conditions and initiation of supervisory review, dispute, revocation, freeze, quarantine, or bounded rollback states, together with corresponding receipts and state transitions.

This figure highlights that safety controls, exception handling, and lifecycle reversibility are governed by defined technical states rather than by unrestricted manual override.

### Computing Environment, Deployment Modes, and Implementation Details

Embodiments of the disclosure may be implemented in software, firmware, hardware, secure enclaves, trusted execution environments, virtualized infrastructure, cloud services, edge nodes, mobile devices, enterprise appliances, institutional gateways, or combinations thereof.

The disclosed modules may be implemented as smart contracts, orchestration services, microservices, containerized workloads, message-driven services, batch jobs, streaming components, secure key-management services, or hybrid combinations. Certain implementations may partition duties across client-side processing, institution-side validation, and shared or distributed receipt anchoring.

Data may be stored in distributed ledgers, permissioned ledgers, append-only logs, relational stores, graph stores, document stores, secure vaults, or hybrid systems, provided that the relevant commitments, proofs, receipts, or state references are preserved in machine-verifiable form.

Networking may occur over public networks, private networks, virtual private networks, institutional intranets, mesh networks, edge fabrics, or mixed environments. Interface transport may use application-programming interfaces, signed message envelopes, event buses, streaming interfaces, or other suitable machine-to-machine protocols.

Key management may include rotation, revocation, delegation, escrow under defined conditions, split-key operation, threshold-signature arrangements, hardware-backed credential storage, and recovery procedures constrained by policy and audit requirements.

The computing environment may also include monitoring infrastructure, observability pipelines, policy-publication systems, standards adapters, exchange gateways, clearinghouse interfaces, archival systems, and privacy-preserving proof services.

### Advantages and Technical Effects

The disclosed architecture provides technical advantages over conventional account-centric, telephone-addressed, and manually administered systems by binding identity, proof, policy, routing, issuance, communications, audit, settlement, inheritance, and rollback semantics into a common machine-verifiable framework.

Illustrative technical advantages include improved portability of identity-linked authority states; improved replay resistance and freshness validation; deterministic policy enforcement across nodes and institutions; machine-verifiable issuance and settlement receipts; authenticated endpoint routing; improved interoperability with heterogeneous external rails; privacy-preserving verification; auditable lifecycle controls; and reduced dependence on a single centralized operator.

The architecture further supports domain-specific overlays without requiring a new trust fabric for each sector. Healthcare, judicial, compliance, governance, and institutional embodiments may therefore reuse the same core technical mechanisms while preserving sector-specific constraints.

These and other advantages arise from the particular combination of canonicalized Event Records, Time-Proofs, signed and versioned Policy Bundles, atomic mint-and-bind transitions, Signed Endpoint Records, tamper-evident commitments, privacy-preserving presentations, and bounded lifecycle controls described throughout this specification.

### Non-Limiting Variations and Additional Embodiments

Although many examples herein refer to ReadName, TimeCoin, RedName, BEIProof, Economic Nodes, or Institutional Adapters, such labels are non-limiting and are used for drafting convenience. Equivalent naming conventions, partitioning strategies, storage models, or deployment profiles may be used without departing from the inventive concepts described herein.

Likewise, although certain examples use domain-based or namespace-based routing, other resolvable identifier systems, role-based endpoint structures, or authenticated discovery layers may be employed. Similarly, although certain examples refer to value units, credits, rights states, or settlement states, the same technical fabric may support non-fungible, fungible, ledger-anchored, off-chain referenced, or hybrid representations.

The order of operations described in particular embodiments may be varied, parallelized, partially deferred, or partitioned across services, provided that the relevant verification, policy, receipt, and lifecycle controls are preserved.

### Scope of the Disclosure

The present disclosure is intended to support claims directed to systems, methods, apparatuses, devices, instructions, non-transitory computer-readable media, distributed services, protocol objects, routing objects, issuance objects, settlement objects, audit objects, and lifecycle-control objects that perform or facilitate substantially the functions described herein.

No statement in this specification should be interpreted as requiring all embodiments to include all described modules, figures, sector overlays, deployment examples, endpoint roles, or implementation details unless expressly recited in a claim. Features described in connection with one embodiment may be combined with features described in connection with another embodiment unless stated otherwise or unless technically incompatible.

References to examples, embodiments, implementations, overlays, sectors, or deployment names are illustrative and non-limiting. The scope of protection sought is defined by the claims as properly construed in light of this specification and applicable law.

### Boilerplate and Claim-Interpretation Language

As used herein, singular forms may include plural referents and plural forms may include singular referents unless the context clearly indicates otherwise. Terms such as including, comprising, having, containing, configured to, operable to, may, can, or similar expressions are intended to be open-ended unless expressly stated to the contrary.

Directional, positional, or relational terms are used for drafting convenience only and do not require any particular physical orientation unless expressly recited. Similarly, references to layers, modules, engines, subsystems, nodes, adapters, records, certificates, receipts, or pointers are intended to cover software, hardware, firmware, hybrid, and distributed implementations unless otherwise limited.

Where a function is described in connection with a module, engine, subsystem, node, adapter, or data structure, the function may be performed by one or more cooperating components or may be consolidated into fewer components, and such partitioning is not limiting unless required by a claim.

Headings and section numbers are provided for convenience and organization and are not intended to limit claim scope. Examples, figures, and worked embodiments are illustrative, and equivalent variations may be used consistent with the present disclosure.

1-49. (canceled)

50. A computer-implemented sovereignty architecture, comprising: an identity module configured to generate, register, and manage a self-sovereign digital identifier and an associated identity state associated with a user; a behavior-intake module configured to receive one or more behavior records from one or more authorized sources; a time-proof module configured to generate or verify a cryptographic time-proof that binds a behavior record, or a commitment thereto, to a time reference, a validity window, and a replay-prevention state; a minting engine configured to execute, upon successful verification of the behavior record and the time-proof, a single atomic state transition that issues a value unit and binds the value unit to the identity state associated with the user while generating a mint certificate and a state-transition receipt; a domain-namespace routing layer configured to resolve a human-readable basepoint to one or more signed endpoint records for at least policy retrieval, audit, minting, or settlement; a communication module configured to derive or resolve a numberless communication endpoint associated with the identity state and establish an encrypted communication session through one or more sovereign endpoint nodes; and a tamper-evident data structure configured to store at least one commitment to the mint certificate or to the state-transition receipt.

51. A computer-implemented method for operating a sovereignty architecture, the method comprising: authenticating a user identity state; receiving a behavior record from an authorized source; generating or verifying a time-proof bound to a time reference, a validity window, and a replay-prevention state; determining that the behavior record and the time-proof satisfy a policy-controlled eligibility condition; executing a single atomic state transition that issues a value unit, binds the value unit to the user identity state, and generates a mint certificate and a settlement receipt; anchoring, in a tamper-evident data structure, at least one commitment associated with the mint certificate or the settlement receipt; resolving, through a domain-namespace routing layer, one or more signed endpoint records associated with a human-readable basepoint; and establishing, using a numberless communication endpoint, an encrypted communication session associated with the user identity state.

52. A non-transitory computer-readable medium storing instructions that, when executed by one or more processors, cause the one or more processors to perform operations comprising: receiving a behavior record associated with an identity state; verifying a time-proof having a validity window and replay-prevention state; enforcing a signed policy bundle to determine whether issuance is permitted; executing an atomic issuance-and-binding transition that generates a value unit and a mint certificate bound to the identity state; anchoring a commitment associated with the mint certificate in a tamper-evident data structure; resolving a domain basepoint to one or more signed endpoint records; and establishing an encrypted numberless communication session through a sovereign endpoint node.

53. The architecture of claim 50, wherein the identity module comprises a ReadName module configured to generate a user-defined, inheritable digital identifier.

54. The architecture of claim 50, wherein the identity module further comprises a Domain Bank mapping layer configured to associate the self-sovereign digital identifier with one of a plurality of ecosystem nodes.

55. The architecture of claim 50, wherein the domain-namespace routing layer is further configured to resolve a signed policy bundle having an effective time window and a version identifier, and to provide the signed policy bundle to at least a minting engine, an audit verifier, or a settlement service as an enforcement input.

56. The architecture of claim 50, wherein the identity module further comprises a ReadVault ledger configured to record identity events, delegation states, inheritance states, recovery states, or revocation states.

57. The architecture of claim 56, wherein the ReadVault ledger is configured to support programmable multigenerational inheritance using a privacy-preserving proof or a zero-knowledge-compatible verification flow.

58. The architecture of claim 50, wherein the domain-namespace routing layer is configured to resolve signed endpoint records specifying at least minting endpoints, policy endpoints, audit endpoints, exchange-listing endpoints, clearinghouse endpoints, or settlement endpoints.

59. The architecture of claim 50, wherein the communication module comprises a RedName protocol configured to derive rotating, temporary, or session-bound endpoints without requiring a telephone number or a subscriber identity module as a primary addressing anchor.

60. The architecture of claim 50, further comprising a unified communication-wallet-currency engine linking the identity module, the minting engine, and the communication module through a shared zero-trust ledger fabric.

61. The architecture of claim 50, wherein the communication module or the one or more sovereign endpoint nodes are further configured to generate a communication-state integrity record or receipt comprising at least an endpoint-state reference, a policy-state reference, or a session-validity indication.

62. The architecture of claim 50, further comprising an analytics engine configured to detect anomalous issuance patterns, suspicious routing patterns, or device inconsistencies and to trigger at least one of hold, quarantine, delay, freeze, or bounded corrective action.

63. The method of claim 51, wherein receiving the behavior record comprises receiving a digitally signed behavior record including a commitment to underlying evidence and an issuer identifier associated with the authorized source.

64. The method of claim 51, wherein verifying the time-proof comprises determining whether the time-proof is stale, duplicated, outside the validity window, or inconsistent with a policy-defined rate limit.

65. The method of claim 51, wherein executing the single atomic state transition comprises generating the mint certificate with a reference to a policy version identifier and to the validity window.

66. The method of claim 51, further comprising publishing and enforcing a signed, versioned policy bundle having an effective time window, the policy bundle defining at least one of authorized sources, eligible categories, issuance caps, weighting coefficients, routing rules, privacy constraints, or audit permissions.

67. The method of claim 51, further comprising performing clearinghouse processing including at least one of matching, netting, settlement instruction generation, reconciliation, or interoperability mapping to an external rail.

68. The method of claim 51, further comprising translating, through an interoperability mapping or an institutional adapter, at least one internal issuance, routing, audit, clearing, or settlement object to an external rail or a standardized external message format.

69. The non-transitory computer-readable medium of claim 52, wherein the instructions further cause the one or more processors to perform selective audit using a privacy-preserving proof and to enforce a sector-specific wrapper for at least healthcare, judicial, environmental, educational, public-health, or cultural operation.
